(19) United States
(12) Patent Application Publication
(10) Pub. No.: US 2025/0379366 A1
(43) Pub. Date: Dec. 11, 2025

(54) INTELLIGENT REFLECTING SURFACE AND REFLECTING DEVICE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP)

(73) Assignee: Japan Display Inc., Tokyo (JP)

(21) Appl. No.: 19/307,246

(22) Filed: Aug. 22, 2025

Related U.S. Application Data
(63) Continuation of application No. PCT/JP2024/004663, filed on Feb. 9, 2024.

(30) Foreign Application Priority Data
Feb. 24, 2023 (JP) 2023-027678

(51) Int. Cl. H01Q 15/14

(52) U.S. Cl. CPC H01Q 15/147

(57) ABSTRACT

An intelligent reflecting surface according to an embodiment includes a reflector unit cell including a ground electrode, a first dielectric layer arranged on the ground electrode, a first electrode arranged on the first dielectric layer, a second dielectric layer arranged on the first electrode, and a second electrode arranged on the second dielectric layer and overlapping the first electrode. A dielectric constant of the first dielectric layer is 2.5 or more and 3.5 or less. A thickness of the first dielectric layer is 20 μm or more and 30 μm or less. A dielectric constant of the second dielectric layer is 2.0 or more and to 4.0 or less. A thickness of the second dielectric layer is 10 μm or more and 30 μm or less.

### CROSS-REFERENCE TO RELATED APPLICATIONS

This application is a Continuation of International Patent Application No. PCT/JP2024/004663, filed on Feb. 9, 2024, which claims the benefit of priority to Japanese Patent Application No. 2023-027678, filed on Feb. 24, 2023, the entire contents of each are incorporated herein by reference.

### FIELD

An embodiment of the present invention relates to an intelligent reflecting surface and a reflecting device including the intelligent reflecting surface.

### BACKGROUND

A phased array antenna device controls directivity with an antenna in a fixed state by adjusting the amplitude and phase of a high-frequency signal applied to each of a plurality of antenna elements arranged in a plane. The phased array antenna device requires a phase shifter. For example, Japanese laid-open patent publication No. H11-103201 and Japanese laid-open patent publication No. 2019-530387 disclose a phased array antenna device using a phase shifter that utilizes a change in a dielectric constant due to an alignment state of a liquid crystal.

### SUMMARY

An intelligent reflecting surface according to an embodiment includes a reflector unit cell including a ground electrode, a first dielectric layer arranged on the ground electrode, a first electrode arranged on the first dielectric layer, a second dielectric layer arranged on the first electrode, and a second electrode arranged on the second dielectric layer and overlapping the first electrode, wherein a dielectric constant of the first dielectric layer is 2.5 or more and 3.5 or less, a thickness of the first dielectric layer is 20 μm or more and 30 μm or less, a dielectric constant of the second dielectric layer is 2.0 or more and to 4.0 or less, and a thickness of the second dielectric layer is 10 μm or more and 30 μm or less.

A reflecting device according to an embodiment includes the intelligent reflecting surface described above, and a drive circuit outputting a control signal applied to a first signal.

### BRIEF DESCRIPTION OF DRAWINGS

FIG. 1 is a plan view when a reflector unit cell according to an embodiment of the present invention is viewed from above (from a side where a radio wave enters).

FIG. 2 shows a cross-sectional view of a reflector unit cell corresponding to a section between A1-A2 shown in FIG. 1.

FIG. 3A is a diagram showing a state in which no voltage is applied between a first patch electrode and a ground electrode when a reflector unit cell used in a reflecting device according to an embodiment of the present invention operates.

FIG. 3B is a diagram showing a state in which a control signal is applied to a first patch electrode when a reflector unit cell used in a reflecting device according to an embodiment of the present invention operates.

FIG. 4 is a plan view showing a configuration of a reflecting device according to an embodiment of the present invention.

FIG. 5 is a plan view showing a configuration of a reflecting device according to an embodiment of the present invention.

FIG. 6 shows a cross-sectional structure of a reflector unit cell in a reflecting device according to an embodiment of the present invention.

### DESCRIPTION OF EMBODIMENTS

At present, fifth-generation communication (5G) is being widely used, but an intelligent reflecting surface using a material having a constant dielectric constant has a fixed reflection direction. On the other hand, in an intelligent reflecting surface using a liquid crystal material as a dielectric, the dielectric constant of a liquid crystal can be changed by adjusting a voltage applied to the liquid crystal, and the reflection direction of a radio wave can be changed. However, in an intelligent reflecting surface using the liquid crystal as the dielectric, in order to obtain desired reflection characteristics, it is necessary to increase the thickness of the dielectric including a resin, a liquid crystal, or the like. In this case, when the thickness of the dielectric including the liquid crystal is increased, there is a problem that the cost increases because the liquid crystal material included in the dielectric also increases. Further, when the thickness of the dielectric is increased, response characteristics of the liquid crystal are reduced.

According to the present invention, it is possible to provide an intelligent reflecting surface having excellent radio wave reflection characteristics and reduced cost. In addition, according to the present invention, it is possible to provide a reflecting device having excellent radio wave reflection characteristics and reduced cost.

Hereinafter, embodiments of the present invention will be described with reference to the drawings and the like. However, the present invention can be implemented in many different aspects, and should not be construed as being limited to the description of the embodiments exemplified below. In order to make the description clearer, the drawings may be schematically represented with respect to the width, thickness, shape, and the like of each part as compared with the actual embodiment, but the drawings are merely examples, and do not limit the interpretation of the present invention. Further, in the present specification and the drawings, elements similar to those described above with respect to the above-described figures are denoted by the same reference signs (or reference signs denoted by a, b, and the like) and redundant description thereof may be omitted. Furthermore, the terms “first” and “second” with respect to the respective elements are convenient signs used to distinguish the respective elements, and do not have any further meaning unless otherwise specified.

In the present specification, a member or region is “above (or below)” another member or region, including, without limitation, when it is directly above (or below) the other member or region, but also when it is above (or below) the other member or region, that is, when another component is included between above (or below) the other member or region.

### First Embodiment

### [Reflector Unit Cell]

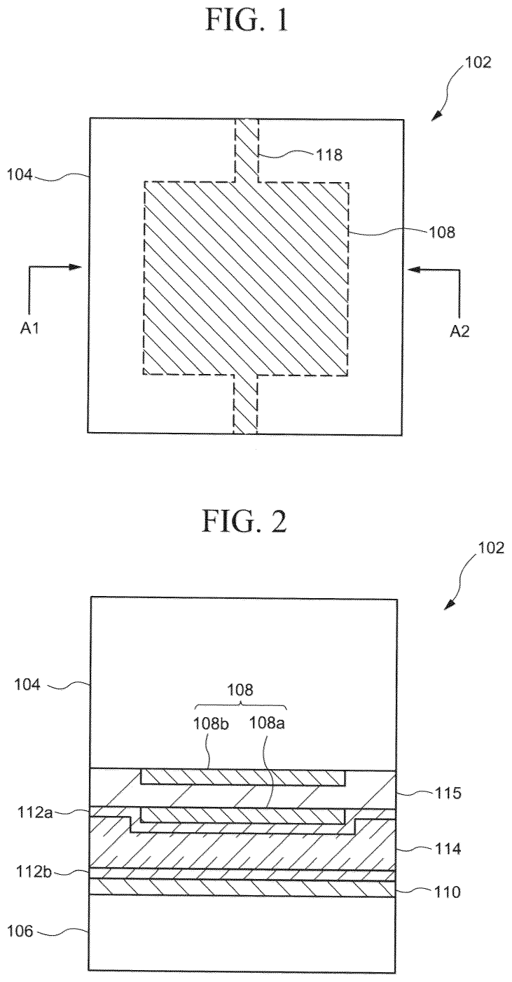

FIG. 1 and FIG. 2 show a reflector unit cell 102 used in an intelligent reflecting surface according to an embodiment of the present invention. FIG. 1 shows a plan view when the reflector unit cell 102 is viewed from above (a side where the radio wave enters), and FIG. 2 shows a cross-sectional view of the reflector unit cell 102 corresponding to a section between A1-A2 shown in FIG. 1.

As shown in FIG. 1 and FIG. 2, the reflector unit cell 102 includes a substrate 106, a ground electrode 110, a first alignment film 112a, a second alignment film 112b, a first dielectric layer 114, a first patch electrode (first electrode) 108a, a second patch electrode (second electrode) 108b, a second dielectric layer 115, and a dielectric substrate 104. The dielectric substrate 104 in the reflector unit cell 102 may also be considered as a dielectric layer forming one layer. Hereinafter, the dielectric substrate 104 will be referred to as a third dielectric layer 104. When the first patch electrode 108a and the second patch electrode 108b are not distinguished from each other, they are simply referred to as a patch electrode 108.

The substrate 106 is an insulating substrate such as glass. The ground electrode 110 is arranged on the substrate 106 and at least partially overlaps the patch electrode 108. The first alignment film 112a is arranged on the second dielectric layer 115 so as to cover the first patch electrode 108a. The second alignment film 112b is arranged on the substrate 106 so as to cover the ground electrode 110. The first dielectric layer 114 is provided between the first patch electrode 108a and the ground electrode 110. The first alignment film 112a is interposed between the first patch electrode 108a and the first dielectric layer 114, and the second alignment film 112b is interposed between the ground electrode 110 and the first dielectric layer 114.

The first dielectric layer 114 is a liquid crystal layer. A liquid crystal material having dielectric anisotropy is used for the first dielectric layer 114. For example, a nematic liquid crystal, a smectic liquid crystal, a cholesteric liquid crystal, or a discotic liquid crystal can be used as the first dielectric layer 114. A dielectric constant ε1 of the first dielectric layer 114 at 28 GHz is preferably 2.5 or more and 3.5 or less. The thickness of the first dielectric layer 114 is 20 μm or more and 30 μm or less. In this case, the thickness of the first dielectric layer 114 becomes thinner as the dielectric constant ε1 of the first dielectric layer 114 becomes higher and becomes thicker as the dielectric constant ε1 becomes lower. When the thickness of the first dielectric layer 114 falls within the above range, the reflectance of the reflector unit cell 102 can be improved while the thickness of the first dielectric layer 114 that is the liquid crystal layer is thinner than in the prior art, and a sufficient amount of phase difference can be obtained.

Although not shown in FIG. 1 and FIG. 2, the second dielectric layer 115 and the substrate 106 are bonded to each other by a sealing material. The second dielectric layer 115 and the substrate 106 are arranged opposite to each other with a gap therebetween, and the first dielectric layer 114, which is the liquid crystal layer, is arranged in a region surrounded by the sealing material. The first dielectric layer 114 is provided so as to fill the gap between the second dielectric layer 115 and the substrate 106. Although not shown in FIG. 2, a spacer for keeping an interval constant may be arranged between the second dielectric layer 115 and the substrate 106.

The second dielectric layer 115 is arranged on the third dielectric layer 104 so as to cover the second patch electrode 108b. The second dielectric layer 115 is made of plastic, resin, ceramic, or the like. For example, a polyimide resin, an acrylic resin, or the like can be used for the second dielectric layer 115. A dielectric constant ε2 at 28 GHz of the second dielectric layer 115 is 2.0 or more and 4.0 or less, and may be, for example, about 2.5. The thickness of the second dielectric layer 115 is 10 μm or more and 30 μm or less, and may be, for example, about 15 μm. In this case, the thickness of the second dielectric layer 115 may be designed to become thinner as the thickness of the first dielectric layer 114 becomes smaller. In other words, the dielectric constant ε2 of the second dielectric layer 115 may be designed to be higher as the dielectric constant ε1 of the first dielectric layer 114 becomes higher.

The first patch electrode 108a and the second patch electrode 108b are arranged so as to overlap each other. The second patch electrode 108b is arranged on the third dielectric layer 104. The above-described second dielectric layer 115 is arranged on the third dielectric layer 104 so as to cover the second patch electrode 108b. Further, the first patch electrode 108a is arranged on the second dielectric layer 115 so as to overlap the second patch electrode 108b.

The patch electrode 108 preferably has a shape having rotational symmetry relative to the center of the patch electrode 108. For example, the shape of the patch electrode 108 may be a four-fold rotational symmetrical shape and may have a quadrilateral or diamond shape in a plan view. In addition, the four-fold rotational symmetrical shape may be a quadrilateral with chamfered corners, or a quadrilateral with rounded corners. Further, the shape of the patch electrode 108 may be circular. For example, FIG. 1 shows the case where the patch electrode 108 is a square in a plan view. Since the patch electrode 108 has rotational symmetry relative to the center of the patch electrode 108, it is possible to reduce the anisotropy related to the reflectance of the radio wave for the vertically polarized wave and the horizontally polarized wave of the incident radio wave. That is, the polarization of the vertically polarized wave and the horizontally polarization wave can be suppressed, and the vertically polarized wave and the horizontally polarized wave can be reflected uniformly.

The shape of the ground electrode 110 is not particularly limited, and has a shape extending over substantially the entire surface of the substrate 106 so as to have a larger area than the patch electrode 108. In other words, the ground electrode 110 is a common electrode commonly provided for other reflector unit cells adjacent to the reflector unit cell 102 shown in FIG. 1 and FIG. 2. The material for forming the patch electrode 108 and the ground electrode 110 is not limited, and is formed using a conductive metal, a metal oxide, or the like.

The first patch electrode 108a is connected to a first wiring 118. The first wiring 118 applies a control signal to the first patch electrode 108a. When a plurality of reflector unit cells 102 is arranged, the first wiring 118 connects a predetermined first patch electrode 108a and the first patch electrode 108a adjacent to the predetermined first patch electrode 108a. The first wiring 118 may be electrically connected to a connecting wiring (not shown) formed on the third dielectric layer 104. The connecting wiring (not shown) transmits a control signal output from a drive circuit described later.

The second patch electrode 108b is in a floating state. In other words, unlike the first patch electrode 108a, the second patch electrode 108b may not be connected to the wiring that transmits the control signal.

The control signal applied to the first patch electrode 108a is a signal of a DC voltage or a polarity-inverted signal in which a positive DC voltage and a negative DC voltage are alternately inverted. A voltage equal to ground or a voltage of an intermediate level of a polarity-inverted signal is applied to the ground electrode 110. An alignment state of liquid crystal molecules included in the first dielectric layer 114 is changed by applying the control signal to the first patch electrode 108a. The dielectric constant of the first dielectric layer 114 having dielectric anisotropy changes according to a change in the alignment state of the liquid crystal molecules. The reflector unit cell 102 may change the dielectric constant of the first dielectric layer 114 by the control signal applied to the first patch electrode 108a, thereby delaying the phase of the reflected wave when reflecting the radio wave.

The frequency bands of the radio waves reflected by the reflector unit cell 102 are a very high frequency (VHF) band, an ultra-high frequency (UHF) band, a microwave (SHF: Super High Frequency) band, a sub-millimeter wave (THF: Tremendously high frequency) band, and a millimeter wave (EHF: Extra High Frequency) band. The liquid crystal molecules of the first dielectric layer 114 are hardly affected by the frequency of the radio wave applied to the first patch electrode 108a, although the alignment of the liquid crystal molecules changes in response to the control signal applied to the first patch electrode 108a. Therefore, the reflector unit cell 102 can control the phase of the reflected radio wave without being affected by the radio wave.

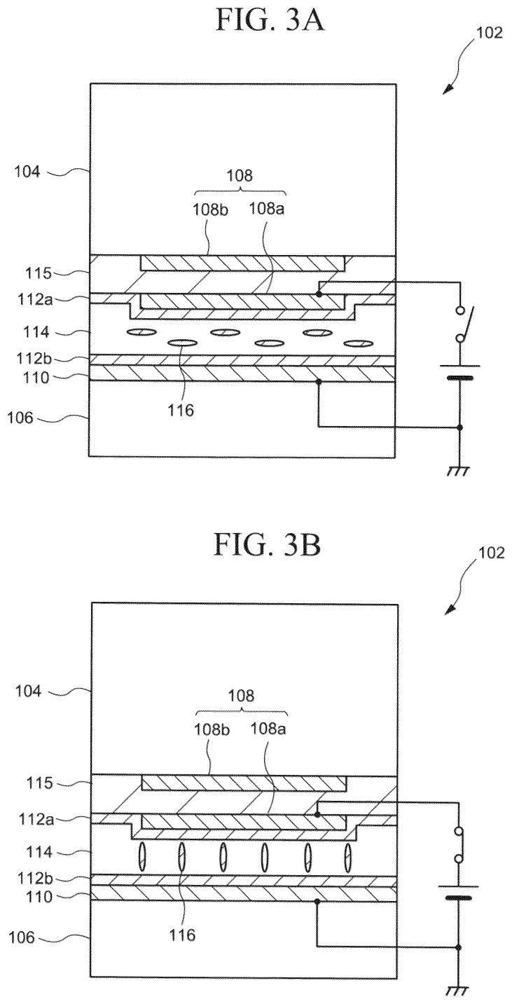

FIG. 3A shows a state in which no voltage is applied between the first patch electrode 108a and the ground electrode 110 (hereinafter, referred to as a “first state”). FIG. 3A shows the case where the first alignment film 112a and the second alignment film 112b are horizontal alignment films. The long axis of a liquid crystal molecule 116 in the first state is aligned parallel to a surface the first patch electrode 108a and a surface of the ground electrode 110 due to the first alignment film 112a and the second alignment film 112b.

FIG. 3B shows a state in which the control signal (voltage signal) is applied to the first patch electrode 108a (hereinafter, referred to as a “second state”). In the second state, the long axis of the liquid crystal molecule 116 is aligned perpendicular to the surface of the first patch electrode 108a and the surface of the ground electrode 110 due to the electric field. An angle at which the long axis of the liquid crystal molecule 116 is aligned can be adjusted by adjusting the magnitude of the control signal applied to the first patch electrode 108a, or in other words, by adjusting the magnitude of the potential difference between the ground electrode 110 and the first patch electrode 108a. It is also possible to align the long axis of the liquid crystal molecule 116 in an intermediate direction between the horizontal direction and the vertical direction by adjusting the magnitude of the control signal.

In the case where the liquid crystal molecule 116 has positive dielectric anisotropy, the dielectric constant of the second state is higher than that of the first state. In the case where the liquid crystal molecule 116 has negative dielectric anisotropy, the apparent dielectric constant of the second state is lower than that of the first state. The first dielectric layer 114 having dielectric anisotropy can also be regarded as a variable dielectric layer. The reflector unit cell 102 can control the phase of the reflected wave so that it is delayed or not delayed by utilizing the dielectric anisotropy of the first dielectric layer 114.

Referring back to FIG. 1 and FIG. 2, the description of the reflector unit cell 102 will be continued. The third dielectric layer 104 is a glass substrate. A dielectric constant ε3 of the third dielectric layer 104 may be about 5.5. In the case where the frequency of the radio wave reflected by the reflector unit cell 102 is λ, the thickness of the third dielectric layer 104 is preferably equivalent to an integer multiple of λ/4 (one-fourth wavelength). For example, if λ=28 GHz, the third dielectric layer 104 may have a thickness of about 1000 μm. Further, if the dielectric constant is the above-described numerical value, the material constituting the third dielectric layer 104 is not limited to glass. In addition, the thickness of the third dielectric layer 104 may be appropriately adjusted according to the magnitude of the dielectric constant ε3 of the third dielectric layer 104. Specifically, in the case where the magnitude of the dielectric constant ε3 of the third dielectric layer 104 is relatively high, the thickness of the third dielectric layer 104 may be relatively thin.

The reflector unit cell 102 used in the intelligent reflecting surface according to an embodiment of the present invention includes three dielectric layers including the first dielectric layer 114, the second dielectric layer 115, and the third dielectric layer 104. By setting the dielectric constants and thicknesses of the three dielectric layers as described above, the thickness of the first dielectric layer 114, which is the liquid crystal layer, can be made thinner than in the prior art while ensuring excellent reflection characteristics and a sufficient amount of phase difference, thereby reducing the cost of the intelligent reflecting surface. Specific examples will be described below.

Assuming the reflector unit cell 102 having the configuration shown in FIG. 2, the relationship between the thicknesses of the first dielectric layer 114, the second dielectric layer 115, and the third dielectric layer 104, and the amount of phase difference and the reflectance of the reflector unit cell was simulated. A CST STUDIO was used for the simulations. In the simulations, the reflector unit cells were compared under the conditions shown in Table 1 below.

TABLE 1

| | Thickness | Thickness | Thickness |
|---|---|---|---|
| | of the first | of the second | of the third |
| | dielectric layer | dielectric layer | dielectric layer |
| | [μm] | [μm] | [μm] |
| Cell 1 | 25 | 15 | 1000 |
| Cell 2 | 50 | 0 | 0 |
| Cell 3 | 50 | 30 | 0 |

In the reflector unit cells of the cell 1, the cell 2, and the cell 3, a glass substrate having a thickness of 1000 μm was used as the substrate 106, a liquid crystal having a dielectric loss tangent of about 0.02, in which a predetermined dielectric constant changes depending on the applied voltage, was used as the liquid crystal in the first dielectric layer 114, an aluminum alloy of size 2.8 mm×2.8 mm was used as the patch electrode 108, polyimide was used as the second dielectric layer 115, and a glass substrate was used as the third dielectric layer 104. In addition, the frequency of the radio wave entering the reflector unit cell was 28 GHz, the dielectric constant ε1 of the first dielectric layer 114 was 2.5 to 3.5, the dielectric constant ε2 of the second dielectric layer 115 was 2.5, and the dielectric constant ε3 of the third dielectric layer 104 was 5.43.

The amount of phase difference and the reflectance of the reflector unit cells of the cell 1, the cell 2, and the cell 3 are shown in Table 2 below.

TABLE 2

| | Amount of phase difference | |
|---|---|---|
| | [deg] | Reflectance [dB] |
| Cell 1 | 266 | 0~−10 |
| Cell 2 | 25 | 0~−22 |
| Cell 3 | 330 | 0~−41 |

As shown in Table 2, in the reflector unit cell of the cell 2 having only the first dielectric layer 114 which is a liquid crystal layer, the amount of phase difference is the smallest. In the reflector unit cell of the cell 3 having two dielectric layers of the first dielectric layer 114 and the second dielectric layer 115, the amount of phase difference was significantly increased as compared with the cell 2, while the reflectance was decreased as compared with the cell 2. In the reflector unit cell of the cell 1 having three dielectric layers of the first dielectric layer 114, the second dielectric layer 115, and the third dielectric layer 104, the amount of phase difference is increased and the reflectance is also improved as compared with the cell 2.

As described above, the reflector unit cell 102 used in the intelligent reflecting surface according to an embodiment of the present invention includes three dielectric layers of the first dielectric layer 114, the second dielectric layer 115, and the third dielectric layer 104, whereby the liquid crystal layer can be thinned while ensuring excellent reflection characteristics and a sufficient amount of phase difference.

### [Radio Frequency Reflector]

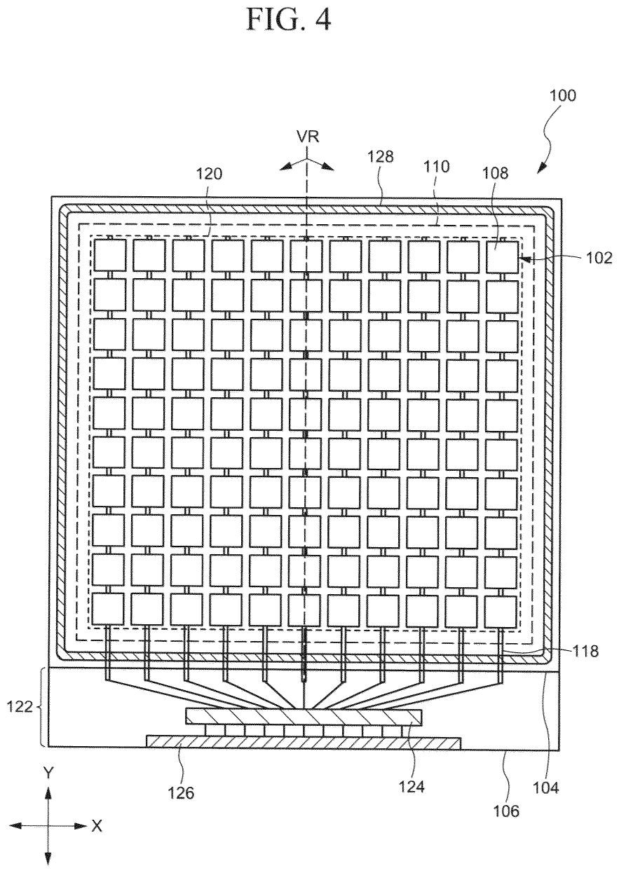

FIG. 4 is a plan view showing a configuration of a reflecting device 100 according to an embodiment of the present invention. The reflecting device 100 includes an intelligent reflecting surface 120. The intelligent reflecting surface 120 includes the plurality of reflector unit cells 102. For example, the plurality of reflector unit cells 102 is arranged in a first direction (X-axis direction shown in FIG. 4) and a second direction (Y-axis direction shown in FIG. 4) orthogonal to the first direction. The reflector unit cell 102 is arranged such that the patch electrode 108 faces the incident surface of the radio wave. The intelligent reflecting surface 120 has a flat plate shape, and a plurality of patch electrodes 108 is arranged in a matrix in the flat plate-shaped surface.

The reflecting device 100 has a structure in which the plurality of reflector unit cells 102 described with reference to FIG. 1 to FIG. 3 is integrated. As shown in FIG. 4, the reflecting device 100 has a configuration in which the third dielectric layer 104 and the substrate 106 on which the ground electrode 110 is provided are arranged so as to overlap each other, and the first dielectric layer (not shown), which is a liquid crystal layer, is arranged between the second dielectric layer (not shown) arranged on the third dielectric layer 104 and the substrate 106. The intelligent reflecting surface 120 is formed in a region where the plurality of patch electrodes 108 and the ground electrode 110 overlap. The cross-sectional structure of the intelligent reflecting surface 120 is the same as the structure of the reflector unit cell 102 shown in FIG. 2 when the individual patch electrodes 108 are viewed. The second dielectric layer (not shown) and the substrate 106 are bonded to each other with a sealing material 128, and the first dielectric layer (not shown) is arranged in a region inside the sealing material 128.

The substrate 106 includes a region facing the third dielectric layer 104 and a peripheral region 122 extending outward from the third dielectric layer 104. A first drive circuit 124 and a terminal part 126 are arranged in the peripheral region 122. The first drive circuit 124 outputs the control signal to the patch electrode 108. The terminal part 126 is a region where a connection with an external circuit is made, and for example, a flexible printed circuit substrate (not shown) is connected. A signal for controlling the first drive circuit 124 is input to the terminal part 126.

As described above, the plurality of patch electrodes 108 is arranged on the third dielectric layer 104 in the first direction (X-axis direction) and the second direction (Y-axis direction). A plurality of first wirings 118 extending in the second direction (Y-axis direction) is arranged on the third dielectric layer 104. Each of the plurality of first wirings 118 is electrically connected to the plurality of patch electrodes 108 arranged in the second direction (Y-axis direction). In other words, the plurality of patch electrodes 108 arranged in the second direction (Y-axis direction) is connected to each other by the first wiring 118. The intelligent reflecting surface 120 has a configuration in which a plurality of patch electrode arrays connected by the first wiring 118 is arranged in the first direction (X-axis direction).

The plurality of first wirings 118 arranged in the intelligent reflecting surface 120 extends to the peripheral region 122 and is connected to the first drive circuit 124 via a connecting wiring. The first drive circuit 124 outputs the control signal applied to the patch electrode 108. The first drive circuit 124 may be configured to output control signals of different voltage levels to the plurality of first wirings 118. As a result, in the intelligent reflecting surface 120, the control signal is applied to the plurality of patch electrodes 108 arranged in in a matrix, for each column (that is, for each patch electrode 108 arranged in the second direction (Y-axis direction)).

The control signal is applied to each of the plurality of patch electrodes 108 arranged in the second direction (Y-axis direction), so that the reflecting device 100 can control the reflection direction of the reflected wave of the radio wave incident on the intelligent reflecting surface 120. That is, the reflecting device 100 can control the traveling direction of the reflected wave of the radio wave irradiated to the intelligent reflecting surface 120 in the left-right direction of the drawing, centered on a reflection axis VR parallel to the second direction (Y-axis direction).

In FIG. 4, since the plurality of patch electrodes 108 arranged in the second direction (Y-axis direction) is electrically connected by the first wiring 118 so as to be electrically equal in potential, it is conceivable to replace the plurality of patch electrodes with a strip-shaped electrode that extends in the second direction (Y-axis direction) instead of the plurality of divided electrodes. However, there is an appropriate range for the dimensions of the patch electrode 108, depending on the wavelength of the reflected radio wave. Therefore, when the electrode is shaped like a strip, the sensitivity to the target wavelength is reduced, and the behavior towards the vertically polarized wave and the horizontally polarized wave is different. Therefore, as shown in FIG. 4, it is preferable to arrange the patch electrodes 108 in an array that is symmetrical relative to the vertically polarized wave and the horizontally polarized wave, and connect the plurality of patch electrodes 108 arranged parallel to the reflection axis VR by the first wiring 118. In addition, although FIG. 4 shows the case where the shape of the patch electrode 108 is a square is shown as an example, it may be circular.

As described above, the reflecting device 100 shown in FIG. 4 includes the intelligent reflecting surface 120 composed of the reflector unit cell 102 described with reference to FIG. 1 to FIG. 3. Therefore, in the reflecting device 100, the first dielectric layer 114, which is the liquid crystal layer, can be made thinner while ensuring excellent reflection characteristics and a sufficient amount of phase difference, thereby reducing the cost.

### Second Embodiment

In the reflecting device 100 shown in the first embodiment described above, since the reflection axis VR is uniaxial, the reflection angle can be controlled in a direction with the reflection axis VR as the rotational axis. On the other hand, in the present embodiment, an example of a reflecting device 100A capable of performing biaxial reflection control is shown. In the following description of the reflecting device 100A, a part different from the reflecting device 100 of the first embodiment will be mainly described.

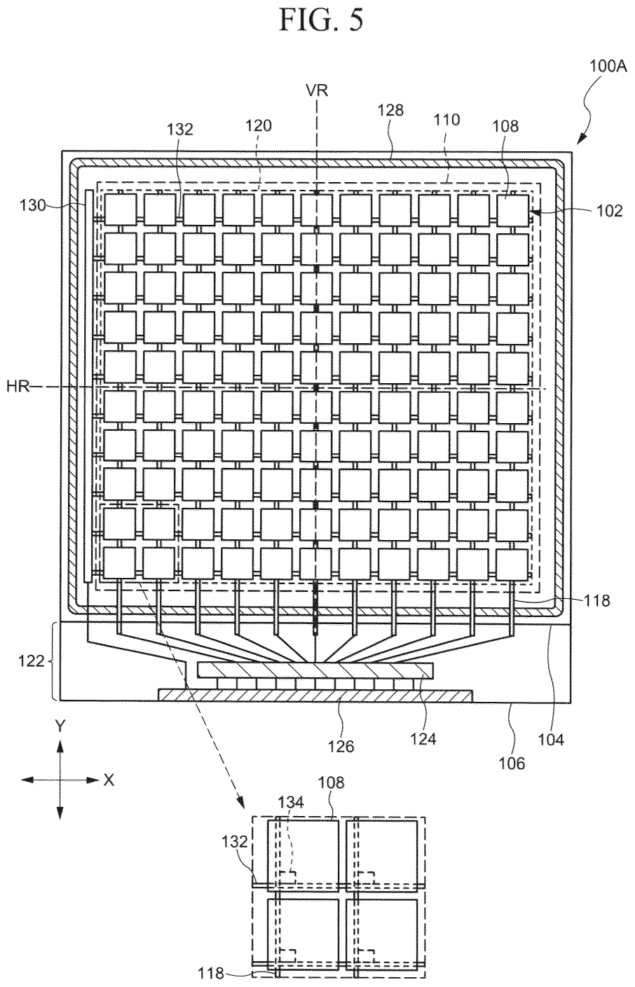

FIG. 5 is a plan view showing a configuration of the reflecting device 100A according to the present embodiment. The reflecting device 100A has a configuration in which the plurality of reflector unit cells 102 described with reference to FIG. 1 to FIG. 3 is integrated. The reflecting device 100A includes a plurality of second wirings 132 extending in the first direction (X-axis direction) in addition to the plurality of first wirings 118 extending in the second direction (Y-axis direction) in the intelligent reflecting surface 120. The plurality of first wirings 118 and the plurality of second wirings 132 are arranged to intersect each other via an insulating layer (not shown). The plurality of first wirings 118 is connected to the first drive circuit 124, and the plurality of second wirings 132 is connected to a second drive circuit 130. The first drive circuit 124 outputs the control signal, and the second drive circuit 130 outputs a scan signal. Signals for controlling the first drive circuit 124 and the second drive circuit 130 are input to the terminal part 126.

An enlarged inset of the arrangement of four patch electrodes 108 and two first wirings 118 and two second wirings 132 is shown in FIG. 5. A switching element 134 is connected to each of the four patch electrodes 108. The switching (on and off) of the switching element 134 is controlled by the scan signal applied to the second wiring 132. The patch electrode 108 in which the switching element 134 is turned on is electrically connected to the first wiring 118, and the control signal is applied. For example, the switching element 134 is formed of a thin film transistor. According to such a configuration, the plurality of patch electrodes 108 arranged in the first direction (X-axis direction) can be selected for each row, and control signals of different voltage levels can be applied to each row.

The reflecting device 100A shown in FIG. 5 can control the traveling direction of the reflected wave of the radio wave irradiated to the intelligent reflecting surface 120 in the left-right direction of the drawing, centered on the reflection axis VR parallel to the second direction (Y-axis direction), as well as in the up-down direction of the drawing, centered on a reflection axis HR parallel to the first direction (X-axis direction). That is, since the reflecting device 100A has the reflection axis VR parallel to the second direction (Y-axis direction) and the reflection axis HR parallel to the first direction (X-axis direction), it is possible to control the reflection angle in the direction with the reflection axis VR as the rotation axis and in the direction with the reflection axis HR as the rotation axis.

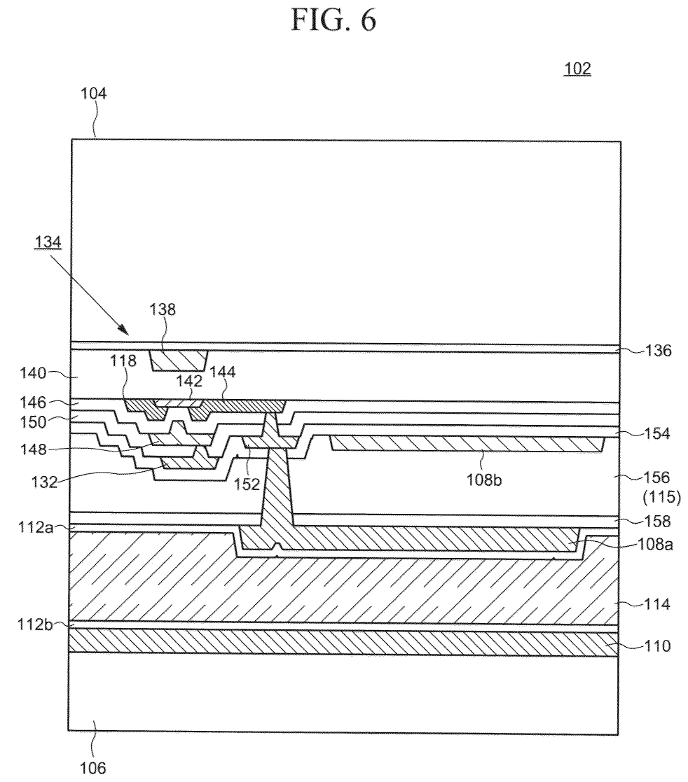

FIG. 6 shows an example of a cross-sectional structure of a part of the reflector unit cell 102 in the reflecting device 100A, including the patch electrode 108 to which the switching element 134 is connected. The switching element 134 is provided on the third dielectric layer 104. The switching element 134 is a thin film transistor having a structure in which a first gate electrode 138, a first gate insulating layer 140, a semiconductor layer 142, a second gate insulating layer 146, and a second gate electrode 148 are stacked. An undercoat layer 136 may be arranged between the first gate electrode 138 and the third dielectric layer 104. The first gate insulating layer 140 is formed to cover the first gate electrode 138. The first wiring 118 is arranged between the first gate insulating layer 140 and the second gate insulating layer 146. The first wiring 118 is arranged so as to be in contact with the semiconductor layer 142. In addition, a first connecting wiring 144 is formed in the same layer as a conductive layer forming the first wiring 118. The first connecting wiring 144 is arranged so as to contact with the semiconductor layer 142. The connection structure of the first wiring 118 and the first connecting wiring 144 to the semiconductor layer 142 is a structure in which one wiring is connected to a source of the transistor and the other wiring is connected to a drain.

A first interlayer insulating layer 150 is arranged to cover the switching element 134. The second wiring 132 is arranged on the first interlayer insulating layer 150. The second wiring 132 is connected to the second gate electrode 148 via a contact hole formed in the first interlayer insulating layer 150. Although not shown, the first gate electrode 138 and the second gate electrode 148 are electrically connected to each other in a region not overlapping the semiconductor layer 142. A second connecting wiring 152 is formed using the same conductive layer as the second wiring 132, on the first interlayer insulating layer 150. The second connecting wiring 152 is connected to the first connecting wiring 144 via the contact hole formed in the first interlayer insulating layer 150.

A second interlayer insulating layer 154 is arranged to cover the second wiring 132 and the second connecting wiring 152. The second patch electrode 108b is formed on the second interlayer insulating layer 154. In addition, a planarization layer 156 is arranged to fill a step of the switching element 134. By arranging the planarization layer 156, the first patch electrode 108a can be formed without being affected by the arrangement of the switching element 134. The planarization layer 156 also functions as the second dielectric layer 115. A passivation layer 158 is arranged on the planar surface of the planarization layer 156. The first patch electrode 108a is arranged on the passivation layer 158 so as to overlap the second patch electrode 108b. The first patch electrode 108a is connected to the second connecting wiring 152 via a contact hole that penetrates the passivation layer 158, the planarization layer 156, and the second interlayer insulating layer 154. The first alignment film 112a is arranged on the first patch electrode 108a.

The ground electrode 110 and the second alignment film 112b are arranged on the substrate 106. A surface of the third dielectric layer 104 on which the switching element 134 and the patch electrode 108 are provided is arranged so as to face a surface of the substrate 106 on which the ground electrode 110 is provided, and the first dielectric layer 114 which is a liquid crystal layer is arranged therebetween.

Each layer formed on the third dielectric layer 104 is formed using the following materials. For example, the undercoat layer 136 is formed of a silicon oxide film. The first gate insulating layer 140 is formed of a resin material such as polyimide or acrylic. For example, the second gate insulating layer 146 is formed of a silicon oxide film or a stacked structure of a silicon oxide film and a silicon nitride film. The semiconductor layer 142 is formed of a silicon semiconductor such as amorphous silicon and polycrystalline silicon, and an oxide semiconductor including a metal oxide such as indium oxide, zinc oxide, and gallium oxide. For example, the first gate electrode 138 and the second gate electrode 148 may be composed of molybdenum (Mo), tungsten (W), or an alloy thereof. The first wiring 118, the second wiring 132, the first connecting wiring 144, and the second connecting wiring 152 are formed using a metal material such as titanium (Ti), aluminum (Al), or molybdenum (Mo). For example, it may be composed of a stacked structure of titanium (Ti)/aluminum (Al)/titanium (Ti), or a stacked structure of molybdenum (Mo)/aluminum (Al)/molybdenum (Mo). The planarization layer 156 is formed of a resin material such as acrylic or polyimide. For example, the passivation layer 158 is formed of a silicon nitride film or the like. The patch electrode 108 and the ground electrode 110 are formed of a metal film such as aluminum (Al) or copper (Cu), or a transparent conductive film such as indium tin oxide (ITO).

As shown in FIG. 6, by connecting the second wiring 132 to a gate of the transistor used as the switching element 134, connecting the first wiring 118 to one of the source and the drain of the transistor, and connecting the first patch electrode 108a to the other of the source and the drain of the transistor, it is possible to select a predetermined reflector unit cell 102 from the plurality of reflector unit cells 102 arranged in a matrix, and to apply the control signal to the first patch electrode 108a of the selected reflector unit cell. Then, the control signal can be applied to each of the plurality of reflector unit cells 102 arranged along the first direction (X-axis direction) or each of the reflector unit cells 102 arranged along the second direction (Y-axis direction) by the switching element 134 provided for each of the reflector unit cells 102 in the intelligent reflecting surface 120, and for example, when the intelligent reflecting surface 120 is upright, the reflection direction of the reflected wave can be controlled in the left-right direction and the up-down direction.

Each of the configurations of the reflecting device, the intelligent reflecting surface, and the reflector unit cell exemplified as an embodiment of the present invention can be appropriately combined and implemented as long as no contradiction is caused. Further, the addition, deletion, or design change of components, or the addition, deletion, or condition change of processes as appropriate by those skilled in the art based on the reflecting device, the intelligent reflecting surface, and the reflector unit cell disclosed in the present invention and the drawings are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. An intelligent reflecting surface comprising a reflector unit cell, the reflector unit cell including:
a ground electrode;
a first dielectric layer arranged on the ground electrode;
a first electrode arranged on the first dielectric layer;
a second dielectric layer arranged on the first electrode; and
a second electrode arranged on the second dielectric layer and overlapping the first electrode, wherein
a dielectric constant of the first dielectric layer is 2.5 or more and 3.5 or less,
a thickness of the first dielectric layer is 20 μm or more and 30 μm or less,
a dielectric constant of the second dielectric layer is 2.0 or more and to 4.0 or less, and
a thickness of the second dielectric layer is 10 μm or more and 30 μm or less.

2. The intelligent reflecting surface according to claim 1 further comprising a third dielectric layer arranged on the second electrode.

3. The intelligent reflecting surface according to claim 2, wherein
the third dielectric layer is made of glass, and
a thickness of the third dielectric layer is an integer multiple of λ/4 when a frequency of a reflected radio wave is λ.

4. The intelligent reflecting surface according to claim 1, wherein
the dielectric constant of the first dielectric layer is variable, and
the dielectric constant of the second dielectric layer is constant.

5. The intelligent reflecting surface according to claim 4, wherein
the first dielectric layer is a liquid crystal layer, and
the second dielectric layer is an organic insulating layer.

6. The intelligent reflecting surface according to claim 1, wherein the second electrode is in a floating state.

7. The intelligent reflecting surface according to claim 1, wherein the thinner the thickness of the first dielectric layer, the thinner the thickness of the second dielectric layer.

8. A reflecting device comprising:
the intelligent reflecting surface according to claim 1; and
a first drive circuit outputting a control signal applied to the first electrode.
